(19) United States
(12) Patent Application Publication
(10) Pub. No.: US 2024/0362537 A1
(43) Pub. Date: Oct. 31, 2024

(54) IMPROVEMENT TOOL RECOMMENDATION ENGINE

(71) Applicant: State Farm Mutual Automobile Insurance Company, Bloomington, IL (US)

(72) Inventors: Sharla Wellman, Mesa, AZ (US); Erin Deknecht, Bloomington, IL (US); Kelli Aickien, Normal, IL (US); Michael Gardner, Powder Springs, GA (US); Petra Misetich, Camas, WA (US); Dan Staver, Bloomington, IL (US); Vicki Cyrulik, Clinton, IL (US); Lori Downer, Chandler, AZ (US)

(21) Appl. No.: 18/644,621

(22) Filed: Apr. 24, 2024

Related U.S. Application Data
(60) Provisional application No. 63/498,406, filed on Apr. 26, 2023.

(51) Int. Cl. G06N 20/00

(52) U.S. Cl. CPC G06N 20/00

(57) ABSTRACT

Described herein are systems and techniques to automatically and with minimal human intervention facilitate determining recommendations for improvement tools to improve user performance and/or modify user behavior based on a variety of data. An input data structure containing sentiment data for a user as well as any one or more pieces of data associated with the user may be provided as input to an improvement tool recommendation model that may be executed to generate improvement tool recommendations for the user. The recommendations may be provided in dedicated interfaces and/or integrated into existing communications and/or communications channels.

### PRIORITY

This application claims priority to U.S. provisional patent application Ser. No. 63/498,406, filed Apr. 26, 2023, which is incorporated herein by reference in its entirety.

### TECHNICAL FIELD

The present disclosure relates to the aggregation of data associated with a user's behavior, attitude, emotions, performance, and other conditions for input to a model trained to determine and generate particular output to assist the user in improving performance, modifying behavior, and implementing habit improvements.

### BACKGROUND

Identifying and providing opportunities to improve user performance or modify user behavior is currently a largely manual process with training and resources typically provided to a user for individual task performance. While this may assist in improving user performance or otherwise modifying behaviors associated with a particular task, the effects of such individual-task-associated behavior modification tools may be temporary and may lack the follow-up and reinforcement needed to ensure that behavior modification effects becomes a permanent change in user behavior. Such behavior modification tools are also typically focused on individual tasks without consideration of integrating improved performance and/or behavior modification into a more holistic behavior modification process.

### SUMMARY

The systems and methods described herein automatically and with minimal human intervention facilitate determining recommendations for improvement tools to improve user performance and/or modify user behavior based on a variety of data. An input data structure containing sentiment data for a user as well as any one or more pieces of data associated with the user may be provided as input to an improvement tool recommendation model that may be executed to generate improvement tool recommendations for the user. The recommendations may be provided in dedicated interfaces and/or integrated into existing communications and/or communications channels

For example, the techniques described herein may relate to a method, comprising receiving, by an improvement tool data determination system, user data comprising subjective user data associated with a user, communications channel data associated with the user, and timing data associated with the user; generating, by the improvement tool data determination system, an input data structure based on the user data; executing, by the improvement tool data determination system, an improvement tool data determination component using the input data structure as input to generate improvement tool data output, wherein the improvement tool data determination component is configured to determine and provide, in the improvement tool data output, based at least in part on the subjective user data, the communications channel data, and the timing data, a communications channel, a time window, and an improvement tool; generating, by the improvement tool data determination system, based at least in part on the communications channel and the improvement tool, an improvement tool data presentation element comprising an indication of the improvement tool; and presenting, by the improvement tool data determination system, based at least in part on the time window, the improvement tool data presentation element on a computing device.

The techniques described herein may also relate to an improvement tool data presentation element that comprises a user-selectable control that, when activated, initiates execution of the improvement tool. The techniques described herein may further relate to presenting the improvement tool data presentation element comprises integrating the improvement tool data presentation element into a communication associated with the communications channel. Such a communication may be one of an email, a message, or a social media post. An improvement tool data determination component may include one or more of a machine-learned model or a rules-based model. Subjective user data may include one or more of current user sentiment data or historical user sentiment data. A time window may be associated with a scheduled event associated with the user and represented in the timing data.

The techniques described herein may relate to a non-transitory computer-readable medium comprising instructions that, when executed by one or more computer processors, cause the one or more computer processors to perform operations comprising receiving user data comprising subjective user data associated with a user, communications channel data associated with the user, and timing data associated with the user; generating an input data structure based on the user data; executing an improvement tool data determination model using the input data structure as input to generate improvement tool data output, wherein the improvement tool data determination model is trained to determine and provide, in the improvement tool data output, based at least in part on the subjective user data, the communications channel data, and the timing data, a communications channel, a time window, and an improvement tool; generating based at least in part on the communications channel and the improvement tool, an improvement tool data presentation element comprising an indication of the improvement tool; and presenting, based at least in part on the time window, the improvement tool data presentation element on a computing device.

The techniques disclosed herein may also include presenting the improvement tool data presentation element comprises integrating the improvement tool data presentation element into a communication associated with the communications channel. Such a communication may be one of an email, a message, or a social media post. In the disclosed techniques, the time window is associated with a scheduled event associated with the user and represented in the timing data. In the disclosed techniques, the subjective user data may include data representing one or more of a change of user sentiment data or a rate of change of user sentiment data. The communications channel data comprises data representing content of communications associated with a communications channel.

The techniques described herein may also relate to a system that may include one or more processors; and a non-transitory memory storing computer-executable instructions that, when executed, cause the one or more processors to perform operations comprising receiving user data comprising subjective user data associated with a user, communications channel data associated with the user, and timing data associated with the user; generating an input data structure based on the user data; executing an improvement tool data determination model using the input data structure as input to generate improvement tool data output, wherein the improvement tool data determination model is trained to determine and provide, in the improvement tool data output, based at least in part on the subjective user data, the communications channel data, and the timing data, a communications channel, a time window, and an improvement tool; generating based at least in part on the communications channel and the improvement tool, an improvement tool data presentation element comprising an indication of the improvement tool; and presenting, based at least in part on the time window, the improvement tool data presentation element on a computing device.

The techniques disclosed herein may also include communications channel data that includes data representing content of communications associated with a communications channel. In the disclosed techniques, presenting the improvement tool data presentation element may include integrating the improvement tool data presentation element into a communication associated with the communications channel. This communication may be one of an email, a message, or a social media post. In the disclosed techniques, presenting the improvement tool data presentation element comprises generating a graphical user interface comprising the improvement tool data presentation element. The subjective user data May include data representing a user sentiment data trend.

The techniques described herein may also relate to system for determining improvement tool recommendation data, the system comprising means for receiving user data comprising subjective user data associated with a user, communications channel data associated with the user, and timing data associated with the user; means for generating an input data structure based on the user data; means for executing an improvement tool data determination model using the input data structure as input to generate improvement tool data output, wherein the improvement tool data determination model is trained to determine and provide, in the improvement tool data output, based at least in part on the subjective user data, the communications channel data, and the timing data, a communications channel, a time window, and an improvement tool; means for generating based at least in part on the communications channel and the improvement tool, an improvement tool data presentation element comprising an indication of the improvement tool; and means for presenting, based at least in part on the time window, the improvement tool data presentation element on a computing device.

This Summary is provided to introduce a selection of concepts in a simplified form that are further described below in the Detailed Description. This Summary is not intended to identify key and/or essential features of the claimed subject matter, nor is it intended to be used as an aid in determining the scope of the claimed subject matter. The term “techniques,” for instance, can refer to system(s), method(s), computer-readable instructions, module(s), component(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar and/or identical items.

FIG. 1 is a block diagram depicting an example improvement tool recommendation system according to the examples described herein.

FIG. 2 is a block diagram depicting example input and output data structures and various components of an example improvement tool recommendation system according to the examples described herein.

FIG. 3 is a flow diagram illustrating an example process for determining and providing improvement tool recommendations according to the examples described herein.

FIG. 4 is a flow diagram illustrating an example process for determining and using sentiment data in an improvement tool recommendation system according to the examples described herein.

FIGS. 5-12 illustrate example interfaces that may be generated by the disclosed improvement tool recommendation system based on data generated and/or determined using the techniques described herein.

FIG. 13 illustrates several improvement tool recommendation generation examples that may be implemented using the improvement tool recommendation system and related techniques according to the examples described herein.

FIG. 14 illustrates an example system architecture for a computing device that may be used to implement the systems and architectures described herein.

The detailed description is set forth with reference to the accompanying figures. In the figures, the left-most digit(s) of a reference number identifies the figure in which the reference number first appears. The use of the same reference numbers in different figures indicates similar or identical items.

### DETAILED DESCRIPTION

A variety of techniques have been developed in an effort to improve the performance and satisfaction of employees, associates, managers, supervisors, and others that operate within an organization (referred to herein generally as “users”). Various programs and systems for coaching, mentoring, training, and otherwise assisting users to improve various aspects of the users' experience within an organization have been developed (referred to herein generally as “improvement tools”). Such programs and systems may be successful for some users while less successful for others. The success of user improvement systems and programs may depend heavily on the individual user participating in the system or program. Each user has an individual history of training and educational experience. Each user further has an individual employment history and situation, such as the position held currently within an organization, position(s) held previously within the organization, current and past performance, position(s) held at other organizations, current and previous supervisors, current and previous coworkers, etc. Furthermore, each user has an individual personality, attitudes, and moods, including general feelings about the organization, particular feelings about roles and/or tasks that may be performed by or otherwise associated with the user, etc. Any or all of these factors may affect the success of an improvement tool for a particular user.

A single improvement tool may have some effect on a user after a single exposure to the tool. However, in order to improve overall user performance, behavior, and satisfaction, it may be more effective to build and sustain improved user habits. This may be accomplished by repeatedly providing appropriate improvement tools and accompanying rewards at appropriate times for a particular user. For example, a holistic assessment of a user's current situation based on a variety of organizational and personal data may be used to determine an appropriate improvement tool for presentation to the user at a current time. However, due to the nature and quantity of such data for each individual user, and because an organization may have many (e.g., thousands or more) individual users, it may be challenging to routinely and efficiently perform such assessments and repeatedly provide suitable improvement tools. Doing so manually (e.g., by human users) for such a complex and large organization with many users is likely impossible to do in reasonable timeframes.

The systems and techniques disclosed herein may be used to aggregate data associated with a particular user from a variety of sources and of a variety of types into one or more data structures that may be used as input to one or more machine-learned and/or rules-based models. The model(s) may be executed to generate output that indicates one or more recommended improvement tools for a particular user at a particular time. The data collection interfaces and the improvement tool recommendation data presentation interfaces described herein may be presented to a user using a variety of channels to facilitate frequent data collections, maintenance of current user and contextual data, and the presentation of temporally and situationally appropriate improvement tool recommendations.

In examples, user sentiment data may be collected (and, in some examples, quantified) that represents a user's mood, feelings, and/or satisfaction in general, associated with a particular task, role, and/or situation, etc. Sentiment data may be one form of subjective user data, any form of which may be collected and processed as described herein in regard to sentiment data. Such sentiment data may also be associated with a particular time (e.g., the time of collection of such data). User employment data may also be collected and/or determined representing, for example, a current role within an organization; currently assigned shift(s); current geographical location; user name and/or other identifying data; one or more previous roles in the organization; current and/or previous supervisors, managers, etc.; current and/or previous coworkers; current and/or previous direct reports, employees under supervision, etc.; user age; user tenure with the organization; etc. User training, education, and/or improvement tool exposure data may also be collected and/or determined representing the user's education, certifications, completed and/or initiated training courses, improvement tool exposures, etc. User scheduling and communications data may also be collected and or determined representing a user's schedule, meeting participation, and/or communications content (e.g., email, chat, texts, calls, etc.). Scheduling data may alternatively be referred to herein as “timing data.” Particular events associated with the user may also be collected and/or determined, such as a particular date and/or time of significance (e.g., deadline, milestone, user-determined, supervisor-determined, etc.).

Any such user data, and any other data that may be used for improvement tool determinations, may be collected within any of a variety of channels. For example, such data may be collected via interfaces presented to a user in calendaring systems, communications systems (e.g., email, chat, etc.), human resources systems, and/or any other systems with which the user may interact and that may not necessarily be associated with a dedicated improvement tool recommendation system. Any such user data, and any other data that may be used for improvement tool determinations, may be stored in one or more data structures that may also include contextual data and/or other data, such as a time associated with the creation and/or collection of the data, a time of participation, a time of completion, etc. As will be appreciated, at least some portions of these various types of data may overlap or otherwise be associated with the same situation. For example, a particular user may have sent communications about a training course that is represented as a meeting on the user's schedule that the user attended and for which the user provided (e.g., sentiment) feedback.

The collected user data may be processed to generate one or more data structures that may be used as input to an improvement tool recommendation model (e.g., one or more rules-based models, one or more machine-learned models, or any combination thereof). The input data structures may further include contextual data, which may or may not be directly associated with the particular user, such as organizational goal data, organizational event data, a time and date, a software context within (e.g., a software program or user interface used to collect the user data, a form of data collection, a user responsiveness, any form of software and/or hardware interaction characteristic, etc.), an event trigger or related data (e.g., activity initiation, activity completion, event occurrence, event anniversary, etc.), etc.

The input data structure(s) may be provided as input to a machine-learned improvement tool recommendation model that may be trained to determine one or more particular improvement tools for a particular user based on the current user data. Alternatively, the input data structure(s) may be provided as input to one or more improvement tool data determination components configured to perform operations as described herein in regard to improvement tool recommendation models. In examples, a particular item and/or event may trigger the generation of this input and the execution of the machine-learned model. For example, the disclosed system may be configured to execute a machine-learned improvement tool recommendation model daily and/or in response to a daily automated “check-in” executed by the system to gather user (e.g., sentiment) input. Alternatively or additionally, the disclosed system may be configured to detect particular events that trigger a collection and/or generation of current user data that is then automatically used to generate and provide input to the machine-learned model to generate improvement tool output. For example, the system may be configured to detect a change in particular types of user data (e.g., current user sentiment, user role, user supervisor, etc.), determine whether such changes trigger an improvement tool analysis, and, if so, generate input data for the machine-learned model based on current user data to determine improvement tool output. Alternatively or additionally, the system may be configured to process user data substantially continuously so that any (e.g., substantive) change in data associated with a particular user may trigger a generation of improvement tool output by the machine-learned model. For example, the model may be executed based on any new communication, sentiment survey response, shift change, etc. to ensure that current and up-to-date recommendations for improvement tools are provided to a user based on the latest available data.

Note that “improvement tool data” generated by a machine-learned model as described herein does not necessarily include an indication that an improvement tool be recommended to a user. In some examples, the machine-learned model may determine that, based on the received input data, there may be no current improvement tool that should be recommended to the associated user. In examples, that machine-learned model and/or the associated systems executing the model may be configured to limit recommendations or limit the executing of the model to generate recommendations. For example, the system may be configured to determine improvement tool recommendations no more than once an hour, once a day, once a week, etc. Alternatively or additionally, the system may be configured to determine recommendations or execute the model to generate recommendations at least a number of times in a time period. For example, the system may be configured to determine improvement tool recommendations at least once an hour, once a day, once a week, etc.

One or more of a variety of improvement tools may be recommended by the machine-learned model and/or provided to a user by the system. Improvement tools may range from very simple examples, such as brief textual content (e.g., a motivational saying, a recommendation to take a break, etc.) to sophisticated interactive examples, such as gamified interactive audio and video content (e.g., a video game, a video with periodic quizzes, etc.). Example improvement tools may also include human interaction, such as live courses, one-on-one and/or group coaching, interactive games involving other people, and any other activities involving other people (e.g., users, supervisors, managers, coaches, counselors, etc.), any of which may be conducted in person or virtually (e.g., on-line). Various examples are set forth herein.

Improvement tool recommendation data, and any other data that may be used for improvement tool recommendations, may be presented to a user within any of a variety of channels. For example, such data may be provided in interfaces presented to a user in calendaring systems, communications systems (e.g., email, chat, etc.), human resources systems, and/or any other systems with which the user may interact and that may not necessarily be associated with a dedicated improvement tool recommendation system. Similarly, improvement tools may also be presented in a variety of channels that may not necessarily be associated with a dedicated improvement tool recommendation system.

One or more other actions may also, or instead, be performed based on model-generated improvement tool data. For example, improvement tool data may be processed to determine one or more notifications that may be transmitted to one or more systems for presentation to any one or more of the user, a supervisor, a coach, a mentor, a human-resources representative, etc. Such notification may indicate the recommended improvement tool(s), if any, and/or any other model-determined data, such as an overall user sentiment, an indication of habit development progress, a training or education score, etc. Improvement tool data may also, or instead, be used to initiate one or more other automated or partially automated processes, such as initiating a training course or series of courses for the user, generating a training or improvement tool program for the user, initiating an action plan involving one or more of a variety of resources for the user, scheduling a meeting with a coach or mentor, generating a “reward” associated with a type of progress (e.g., habit development progress, training progress, coaching progress, etc.), etc. Rewards as described herein may be any incentive that may be provided for the completion of an activity or positive performance. For example, a reward may be an item or something of value (e.g., merchandise, lunch, time-off, etc.) or “points” that may be used to “purchase” such items, awards, naming to a list of exceptional users, inclusion in an announcement of exceptional users, etc.

The improvement tool recommendation models described herein may be one or more rules-based models of any type executing in any manner, one or more machine-learned models of any type executing in any manner, or a combination thereof. For example, an improvement tool recommendation model may be an open-source model, a proprietary model, or a combination thereof, implemented in one or more neural networks of any type (e.g., a convolutional neural network). Multiple models may be configured to execute in sequence, where a model may use output from one or more other models as at least part of its input to generate further output.

The improvement tool recommendation models described herein may be trained using various types of training data. For example, such models may be trained using preconfigured user data and/or contextual data with associated improvement tool data. Such training data may be human-generated and/or automatically generated. For example, an initial training data set used to train an improvement tool recommendation model may include human-generated user/context/improvement tool data. The model may be executed using actual user and contextual data to generate improvement tool data output. The actual user and contextual data along with the resulting improvement tool data output may then be used as further training data to further refine the model (e.g., with to without human and/or automated training data adjustment and/or optimization). Other forms of training data may also, or instead, be used and are contemplated as within the scope of this disclosure.

The improvement tool recommendation models described herein may also be provided with data representing the currently available improvement tools. As will be appreciated, new and updated improvement tools may be generated often, while older or obsolete improvement tools may be removed from a pool of available improvement tools. Various characteristics, attributes, and other data related to such tools may be provided to an improvement tool recommendation model during training and/or inference for use in determining improvement tool recommendation output.

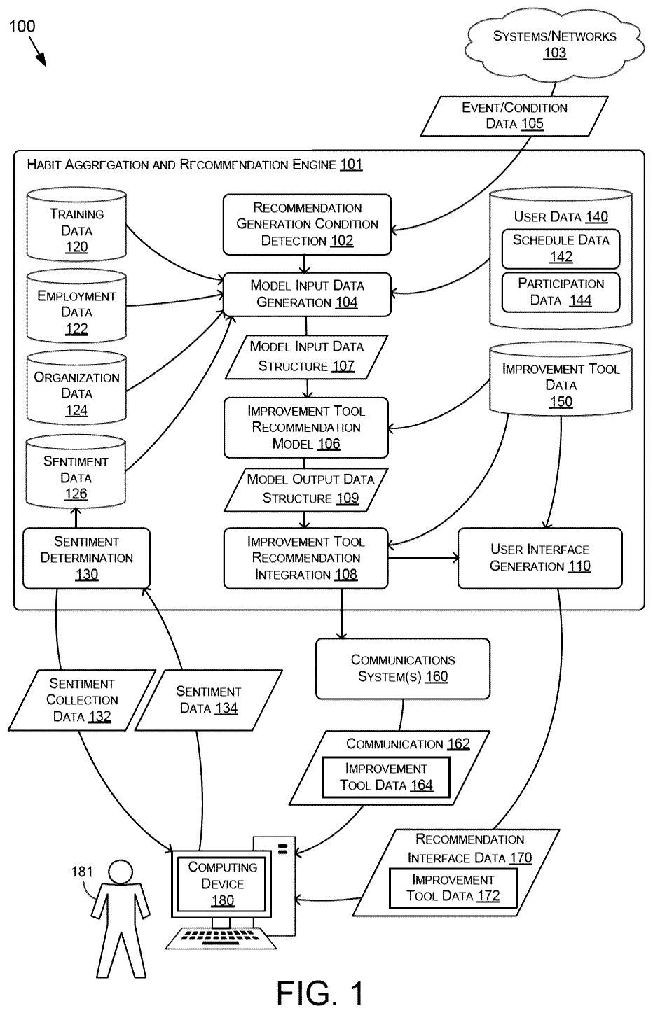

FIG. 1 illustrates an example habit improvement system 100 and associated components and systems. Any one or more aspects of the examples described in this disclosure, and any combination of any one or more of the aspects described herein, may be implemented on a system such as system 100 and/or any system or combinations of systems that may include one or more aspects of the system 100 as described herein.

A habit aggregation and recommendation engine 101 may receive event and/or condition data 105 from various systems and/or networks 103. Such data may be processed to identify trigger conditions and/or events that may then cause the habit aggregation and recommendation engine 101 to determine improvement tool recommendations and perform actions to facilitate use of such tools by one or more users. Event and/or condition data 105 may be any type of data as described herein and/or that may be detected by the habit aggregation and recommendation engine 101. For example, event and/or condition data 105 may be communications exchanged between users, expiration of a timer and/or initiation of a reminder about an event (e.g., as stored in and/or executed by a calendar application), detection of an event initiation and/or completion, executions of an application, receipt of user input, etc.

In examples, the habit aggregation and recommendation engine 101 may include a recommendation generation condition detection component 102 that may process the event/condition data 105. The recommendation generation condition detection component 102 may determine, in examples based on the event and/or condition data 105, whether a condition exists to initiate an improvement tool determination and recommendation process. In making this determination, the recommendation generation condition detection component 102 may process other data that may be used instead of, or in conjunction with, event and/or condition data 105. For example, the recommendation generation condition detection component 102 may also, or instead, process sentiment data as described herein, training data, employment data, user data, organization data, contextual data, etc., to determine whether a recommendation generation condition exists.

For example, data representing meeting attendance (e.g., based on a user's calendar or other records, examples presented here as “huddle” attendance) or other scheduling data may serve as a data source for the recommendation generation condition detection component 102. In another example, user development plan progress or other action plan progress (examples presented here as “pathway progress”) may serve as a data source for the recommendation generation condition detection component 102. In another example, user communications and/or scheduling data (examples presented here as “YAMMER engagement” and “OUTLOOK,” and may also, or instead, include similar systems and applications, such as “VIVA ENGAGE”) may serve as a data source for the recommendation generation condition detection component 102. In another example, user sentiment data (examples presented here as “REAL Insight Pulse data” and “Employee Listening Platform”) may serve as a data source for the recommendation generation condition detection component 102. In another example, other activities in which the user has participated or for which the user is scheduled to participate (examples presented here as “home grown games & interactive”) may serve as a data source for the recommendation generation condition detection component 102. In still other examples, user employment, training, demographic, and/or other organizational and/or human resources data associated with the user (examples presented here as human capital management data or “HCM”) may serve as a data source for the recommendation generation condition detection component 102. Other data may also be provided to and/or processed by the recommendation generation condition detection component 102 for detecting trigger events or conditions and/or for use in determining whether to initiate an improvement tool determination and recommendation process, including executing one or more improvement tool recommendation models, including, but not limited to, any of the user data and contextual data described herein.

The data sources that may be used by the recommendation generation condition detection component 102 to obtain the data it processed to identify triggering conditions may include a training data store 120 that may store training and/or educational data associated with individual users. Such data sources may also, or instead, include an employment data store 122 that may store current and historical employment data associated with individual users (e.g., current and past employers, employment durations and/or dates, salary information, current and/or past performance ratings and/or reviews, etc.). Such data sources may also, or instead, include an organization data store 124 that may store organizational information associated with individual users, such as current position, organizational structure, direct reports, supervisors, managers, directors, etc. Such data sources may also, or instead, include a sentiment data store 126 that may include current and/or historical sentiment data as described herein.

The data sources that may be used by the recommendation generation condition detection component 102 to obtain the data it processed to identify triggering conditions may also, or instead, include user data store 140. The user data store 140 may store and/or access data associated with a current and/or historical user context for an individual user. For example, the user data store 140 may include schedule data 142 (e.g., timing data) that may represent current and/or historical events, appointments, reminders, meetings, and/or other data that may be associated with a user's activities or other aspects. The user data store 140 may also, or instead, include participation data 144 that may represent current and/or historical activities in which a user has or has not participated. For example, the participation data 144 may include data indicating that a user participating in a particular meeting, declined an invitation to a meeting, etc. The participation data 144 may also include data associated with the event or activity in which the user participated or did not participate, such as other users that did and/or did not participate, the subject of the event or activity, the date and time of the event or activity, the subject or topic of the event or activity, etc. Any one or more other data sources that may store any of a variety of data may serve as a data source for the recommendation generation condition detection component 102.

In examples, the recommendation generation condition detection component 102 may be configured to periodically, regularly, and/or substantially continuously initiate an improvement tool determination and recommendation process. For example, the recommendation generation condition detection component 102 may initiate an improvement tool determination and recommendation process at predetermined time periods (hourly, daily, every set number of minutes, etc.) instead of, or in addition to, initiating such a process based on event and/or condition data 105 and/or other data.

If the recommendation generation condition detection component 102 determines that one or more conditions for initiating an improvement tool determination and recommendation process have been satisfied, the recommendation generation condition detection component 102 may transmit an instruction to a model input data generation component 104 to generate model input that may be used to execute an improvement tool recommendation model to generate model output that may include one or more recommended improvement tools and/or associated data. For example, the model input data generation component 104 may be configured to collect and/or determine various data associated with a particular user and/or a context that it may then use to generate a data structure that may be provided as input to a model that may be executed to determine recommended improvement tools and/or associated data.

In examples, the model input data generation component 104 may determine data for one or more of the training data store 120, the employment data store 122, the organization data store 124, the sentiment data store 126, and/or the user data store 140. Based on this data, the model input data generation component 104 may generate a model input data structure 107 that may be provided as input to an improvement tool recommendation model 106. In some examples, the model input data generation component 104 may also process improvement tool data, such as that stored at an improvement tool data store 150, that may include any type of data associated with one or more improvement tools. Alternatively, the model 106 may have access or knowledge of, and/or may be trained based upon, improvement tool data that may be stored at the improvement tool data store 150.

The model input data structure 107 may include any data in any form that may be used to execute the improvement tool recommendation model 106. For example, the improvement tool recommendation model 106 may be trained to receive, as input, various types of user and/or context data to generate, as output, one or more improvement tools and associated data. This output data may be generated as a model output data structure 109.

The model output data structure 109 may include data representing one or more improvement tools along with, in some examples, data representing one or more forms and/or one or more times of communicating such improvement tool data to a user. For example, for an improvement tool determination and recommendation process initiated based on determining that a particular user has begun participating in a meeting on a particular topic, the improvement tool recommendation model 106 may generate the model output data structure 109 to include data representing one or more improvement tools associated with that topic and data representing a recommendation to offer these one or more improvement tools to the user after the user has ceased participating in the meeting. In such an example, the model may be trained to determine the one or more improvement tools further based on the user's training data (e.g., from training data store 120 as included in the model input data structure 107). For instance, the model may be trained to determine improvement tools that are not already represented in the user's training data, thereby avoiding providing the user with redundant training.

As noted, the improvement tool recommendation model 106 may be configured to determine available improvement tools and associated data from the improvement tool data store 150. The improvement tool recommendation model 106 may access the improvement tool data store 150 at individual executions to ensure that its improvement tool knowledge is current. Alternatively, or in addition, the improvement tool recommendation model 106 may be periodically retrained, for instance, as the data in the improvement tool data store 150 is updated. In such examples, improvement tool data may be included in the training data used to train the improvement tool recommendation model 106.

The output data structure 109 generated by the improvement tool recommendation model 106 may be provided to an improvement tool recommendation integration component 108 that may be configured to determine and implement the means of communicating the recommended improvement tools to the user. The improvement tool recommendation integration component 108 may determine the means of integrating the recommended improvement tool information into one or more communications means in order to provide the recommendation to the user.

The improvement tool recommendation integration component 108 may also obtain other data that may be associated with a user associated with the output data structure 109 and/or the recommendations represented by this data structure. For example, the improvement tool recommendation integration component 108 may determine data such as indications of current progress, sentiment, training progress, action plan progress, tool completions, etc. that may be presented or otherwise processed along with the model output data structure 109 to generate recommendations and/or related information for the user. The improvement tool recommendation integration component 108 may determine such data from any one or more of the training data store 120, the employment data store 122, the organization data store 124, the sentiment data store 126, and/or the user data store 140. The improvement tool recommendation integration component 108 may integrate such data into any improvement tool data that may be used to generate user communications or interfaces (e.g., improvement tool data 164, improvement tool data 172 as described below).

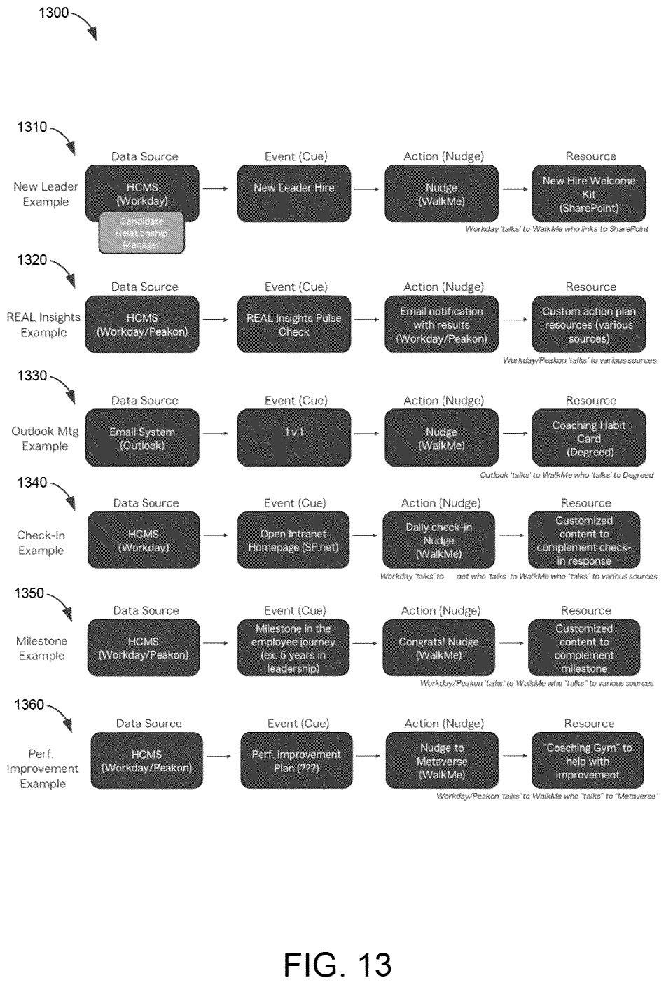

In examples, the improvement tool recommendation integration component 108 may integrate improvement tool recommendation data into existing communications channels. For instance, the improvement tool recommendation integration component 108 may provide instructions to one or more communications systems 160 to integrate data representing one or more improvement tool recommendations (e.g., as an improvement tool data presentation element) into one or more communications processed by the communications system(s) 160. For example, the communications system(s) 160 may be an email server and the improvement tool recommendation integration component 108 may instruct the communications system(s) 160 to integrate one or more presentations of improvement tools and/or one or more controls that may be activated to access one or more improvement tools into one or more emails. When such emails are presented to the user, the user may readily view and/or access the recommended improvement tools using the integrated data (see FIG. 12 and related text for an example of such integration). The improvement tool recommendation integration component 108 may also, or instead, instruct other communications systems to perform similar integration, such as integrating improvement tool recommendation data into calendar events, meetings, and/or appointments and/or associated reminders.

The communications system(s) 160, in response to instructions received from the improvement tool recommendation integration component 108, may generate (e.g., one or more) communication 162 that may include improvement tool data 164. Improvement tool data 164 may include data representing one or more improvement tools (e.g., as determined by the improvement tool recommendation model 106) and/or one or more controls that a user may activate to access one or more improvement tools (e.g., as determined by the improvement tool recommendation model 106).

The communication 162 may be received at a computing device 180 that may be operated by a user 181. The user 181 may be associated with the improvement tool determination and recommendation process initiated to generate the recommended improvement tools (e.g., as represented in the improvement tool data 164). For example, the triggering data detected by the recommendation generation condition detection component 102 may be associated with the user 181 and/or the computing device 180 (e.g., a log-on to a system by the user 181; a selection of an interface control by the user 181; opening an email by the user 181; occurrence of a meeting, appointment, event, or reminder represented on the user 181's calendar; etc.). The computing device 180 may present the communication 162 to the user 181 (e.g., automatically and/or upon activation of a control associated with such communications by the user 181).

Alternatively or additionally, the improvement tool recommendation integration component 108 may instruct a user interface generation component 110 to generate an interface to present to a user with controls and/or display elements representing improvement tool recommendation data. For example, the user interface generation component 110 may generate recommendation interface data 170 in response to instructions received from the improvement tool recommendation integration component 108. The recommendation interface data 170 may include improvement tool data 172 representing improvement tool information to be presented on the interface generated in response to the recommendation interface data 170. The user interface generation component 110 may transmit the recommendation interface data 170 (e.g., including the improvement tool data 172) to the computing device 180 for generation of an interface.

Here again, the user 181 may be associated with the improvement tool determination and recommendation process initiated to generate the recommended improvement tools (e.g., as represented in the improvement tool data 172). The computing device 180 may generate an interface based on the recommendation interface data 170 that may include representations and/or controls associated with the improvement tools represented by the improvement tool data 164.

As described herein, the habit aggregation and recommendation engine 101 may aggregate and process (e.g., preprocess unstructured data to generate structures input data) the determined (e.g., current) contextual and user data to generate one or more data structures that may be used as input data in executing one or more improvement tool recommendation models. Among the data used to determine the output data structures, such as model output data structure 109, may be sentiment data. Sentiment data may be collected and/or determined by the habit aggregation and recommendation engine 101 periodically and/or in response to similar triggers as those used to initiate an improvement tool determination and recommendation process.

In examples, the habit aggregation and recommendation engine 101 may include a sentiment determination component 130 that may be configured to determine current sentiment data from individual users. The sentiment determination component 130 may be configured to determine sentiment when other data has been determined to initiate an improvement tool determination and recommendation process. In such examples, the sentiment determination component 130 may be instructed by one or more other components of the habit aggregation and recommendation engine 101 (e.g., the model input data generation component 104 and/or the recommendation generation condition detection component 102) to determine sentiment for a user associated with the conditions detected that initiates an improvement tool determination and recommendation process (e.g., a log-on to a system by the user 181; a selection of an interface control by the user 181; opening an email by the user 181; occurrence of a meeting, appointment, event, or reminder represented on the user 181's calendar; etc.).

The sentiment determination component 130 may transmit sentiment collection data 132 to the computing device 180. The sentiment collection data 132 may cause the computing device 180 to generate an interface that solicits sentiment data from the user 181 (e.g., as described in examples herein). The computing device 180 may receive responsive data input by the user 181 via interface controls and transmit sentiment data 134 representing such responsive data to the sentiment determination component 130. The sentiment determination component 130 may store the sentiment data 134 at the sentiment data store 126. The sentiment determination component 130 may also, or instead, perform processing of the sentiment data 134 and may store processed sentiment data at the sentiment data store 126. For example, the sentiment determination component 130 may generate one or more sentiment scores or values based on the sentiment data 134, one or more sentiment trends (e.g., in conjunction with processing historical sentiment data for the user 181), etc.

Particular types of recommendations are contemplated as being generated by the habit aggregation and recommendation engine 101. For example, the habit aggregation and recommendation engine 101 may determine and/or generate one or more gamified experiences to be presented to the user that may assist in improved habit forming and skill building. Such gamified experiences may present the opportunity for a user to obtain rewards, such as a position on a leader board, points to collect or unlock reward titles, a badge or title, etc. while participating in such experiences. For instance, completion of improvement tools and/or obtaining scores on improvement tool executions may be associated with rewards.

The habit aggregation and recommendation engine 101 may determine one or more recommended situational improvement tools or “just in time” (JIT) tools that may be appropriate for a user's current situation. For example, the model-generated improvement tool recommendation data may recommend particular coaching and/or other resources intended to assist a user with a current situation, relationship, interaction, or other organizational scenario involving the user. The current situation, relationship, interaction, or other organizational scenario may be provided as input data to the improvement tool recommendation model 106, for example, represented in the model input data structure 107. Similarly, the habit aggregation and recommendation engine 101 may determine one or more recommended targeted improvement tools or “nudges” that may be presented to a user as (e.g., relatively quick) assistance in improved habit forming and skill building. These nudges may be specifically designed to address anticipated issues that may be determined, for example by the improvement tool recommendation model 106, and prepare the user for encountering such issues. For example, the improvement tool recommendation model 106 may recommend brief audio, video, or textual content; short interactive (e.g., gamified) experiences; motivational material; etc. that the user may consume quickly through one or more of a variety of channels. For example, the user may be presented such material in a system that the user is currently using or may frequently use, such as a communications system (e.g., “OUTLOOK”) or other system that the user may routinely access (examples presented here as “WalkMe” and Workday”).

The improvement tools recommended and/or otherwise presented to the user, and the actions based on improvement tool data, may subsequently serve as data that may be used by the habit aggregation and recommendation engine 101 to evaluate conditions and events for trigger data. For example, the completion of an improvement tool may result in an adjustment to user data that may be detected as a trigger to perform another improvement tool recommendation data generation process as described herein.

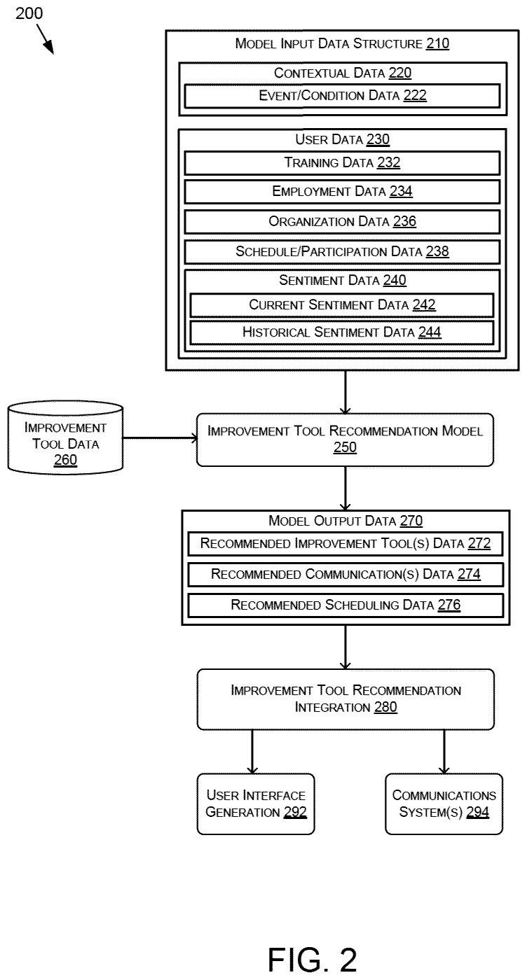

FIG. 2 illustrates an example improvement tool recommendation system 200 and associated data structures that may be generated and/or processed by various components of such a system. Aspects of the system 200 may be implemented in systems such as the system, 100 and the habit aggregation and recommendation engine 101. A model input data structure 210 may be generated for use as input to a model to be executed to determine improvement tool recommendations and related data. The model input data structure 210 may take any effective form.

The model input data structure may include contextual data 220 that may be associated with the condition and/or event determined to initiate an improvement tool determination and recommendation process. For example, the contextual data 220 may conclude event and/or condition data 222 that may include a time and date of the detected trigger event or condition, a hardware and/or software system associated with the trigger event or condition, an interaction or activity associated with the trigger event or condition, etc. Any other contextual data may be included in contextual data 220, such as a user identifier (e.g., username, user identifier, user account number, etc.) and/or a user device identifier (e.g., IP address, network address, etc.).

In some examples, a user may not be explicitly identified in the contextual data 220 or in any other portion of the model input data structure 210 to maintain user anonymity. In such examples, a key (e.g., a hashed value of a username or identifier) or other identifying data may be included in the model input data structure 210 and provided as part of output from the model to which the model input data structure 210 is provided as input. In this way, the output can be matched up with the input 210 to determine the user. This example may be useful where a publicly available model (e.g., a public large language model (LLM)) is used to ensure that user information remains anonymous.

The model input data structure 210 may further include user data 230, which may include a variety of data that may be associated with a user and processed by a model to generate improvement tool recommendations. For example, the user data 230 may include training data 232 that may represent current and/or historical training data and/or educational data associated with a user. The user data 230 may also, or instead, include employment data 234 that may represent current and/or historical employment data associated with a user (e.g., current and past employer(s), employment durations and/or dates, salary information, current and/or past performance ratings and/or reviews, etc.). The user data 230 may also, or instead include organization data 236 that may represent organizational information associated with a user, such as current position, organizational structure, direct reports, supervisors, managers, directors, etc. The user data 230 may also, or instead include schedule and/or participation data 238 that may represent current and/or historical events, appointments, reminders, meetings, and/or other data that may be associated with a user's activities or other aspects and associated participation data as described herein. The user data 230 may also, or instead include sentiment data 240 that may include current sentiment data 242 (e.g., as collected and/or determined by a sentiment determination component) and/or historical sentiment data 244 (e.g., as stored in a sentiment data store).

The model input data structure 210 may be provided to an improvement tool recommendation model 250. The improvement tool recommendation model 250 may be one or more machine-learned models and/or rules-based models. The improvement tool recommendation model 250 may be implemented using one or more machine learning algorithms and/or techniques including, but not limited to, implementation as or in one or more neural networks, such as convolutional neural networks.

The improvement tool recommendation model 250 may be executed using input such as the model input data structure 210 to generate output that indicates improvement tool recommendations and related data, such as, but not limited to, the data associated with the model output data 270. The improvement tool recommendation model 250 may access or be trained with data associated with various improvement tools, such as the improvement tool data stored at an improvement tool data store 260.

In examples, the improvement tool recommendation model 250 may be trained to determine recommended improvement tools based on a combination of current subject user attributes, such as user sentiment, and object user and/or contextual data, such as user training and user scheduling. For example, if a user's sentiment score is substantially negative, indicating that the user is currently tired, stressed out, or otherwise not in a receptive mood, the improvement tool recommendation model 250 may determine to recommend brief and/or simple improvement tools. On the other hand, if a user's sentiment score is substantially positive, indicating that the user is currently happy and likely receptive to training suggestions, the improvement tool recommendation model 250 may determine to recommend more advanced and/or complex improvement tools. The improvement tool recommendation model 250 may further take into account scheduling information (e.g., based on schedule data, does the user have time for a lengthy training or just a simple “nudge?”), participation information (e.g., based on participation data, does the user typically leave incomplete lengthy training sessions while normally completing brief training sessions?), etc.

The improvement tool recommendation model 250 may generate the model output data 270 that may include one or more recommended improvement tools data 272 that may represent the one or more improvement tools recommended for the user associated with the model input data structure 210.

The model output data 270 may also, or instead, include recommended communication(s) data 274 that may represent one or more communications channels and/or means for conveying the recommended improvement tool(s) data 272. For example, the model 250 may determine that the user is more receptive to improvement tool recommendations integrated into an email with content similar to the training content rather than a dedicated improvement tool recommendation email. In another example, the model 250 may determine that the user is more receptive to a dedicated training interface provided at log-on rather than a prompt provided while operating an unrelated application. The model 250 may take into account various data provided in the model input data structure 210 to make such determinations, such as, but not limited to, participation information, training data, etc. For instance, the model 250 may identify, in the recommended communication(s) data 274, a particular unread email in the user's inbox with which an improvement tool recommendation may be integrated. In another example, the model 250 may identify, in the recommended communication(s) data 274, a social media post that may be presented to the user on the user's interface to the related social media application with which an improvement tool recommendation may be integrated.

The recommended communication(s) data 274 may also be based on sentiment data in combination with other data. For example, the model 250 may determine that the user is more receptive to prompts for training provided at log-on if the user's current sentiment (e.g., measured at log-on) is relatively positive and unreceptive otherwise. Therefore, the model 250 may determine to recommend prompting the user to execute a particular improvement tool via the log-on interface if the user's sentiment score is at or above a threshold sentiment score value. On the other hand, the model 250 may determine to recommend prompting the user to execute the particular improvement tool via another application if the user's sentiment score is below the threshold sentiment score value. Any other combinations of data may be used to determine the recommended communication(s) data 274.

The model output data 270 may also, or instead, include recommended scheduling data 276 that may represent one or more times for conveying the recommended improvement tool(s) data 272. For example, the model 250 may determine that the user is more receptive to improvement tool recommendations at log-on rather than later in the day or near end-of-shift. In another example, the model 250 may determine that the user is more receptive to training recommended at consistently similar times of day rather than training offered at random times. The model may take into account various data provided in the model input data structure 210 to make such determinations, such as, but not limited to, participation information, schedule data, etc.

The recommended scheduling data 276 may also be based on sentiment data in combination with other data. For example, the model 250 may determine that the user is more receptive to prompts for training provided at the end of the day if the user's current sentiment (e.g., measured at midday or late in the day) is relatively positive and unreceptive otherwise. Therefore, the model 250 may determine to recommend prompting the user to execute a particular improvement tool shortly at the end of the day if the user's sentiment score is at or above a threshold sentiment score value. On the other hand, the model 250 may determine to recommend prompting the user to execute the particular improvement tool early the following day if the user's current sentiment score is below the threshold sentiment score value. Any other combinations of data may be used to determine the recommended scheduling data 276.

As will be appreciated, the model 250 may be trained to account for many variables, determining, for example, the optimal improvement tool to recommend at a particular time or during a particular time window and via a particular communications channel.

The model output data 270 may be provided to an improvement tool recommendation integration component 280 that may be configured to determine and implement the means and/or times of communicating the recommended improvement tools to the user. The improvement tool recommendation integration component 280 may determine one or more communications channels, for example, based on the recommended communication(s) data 274, and/or one or more times of providing the recommended improvement tools to the user, for example, based on the recommended scheduling data 276.

The improvement tool recommendation integration component 280 may also obtain other data that may be associated with a user associated with the model output data 270 and/or the recommendations represented by this data. For example, the improvement tool recommendation integration component 280 may determine data such as indications of current progress, sentiment, training progress, action plan progress, tool completions, etc. that may be used to generate and/or provide improvement tool recommendations and/or related information for the user. In examples, the improvement tool recommendation integration component 280 may use existing application states and/or data to provide such recommendations, such as identifying suitable email(s), message(s), or social media post(s) with which to integrate recommendations. “Messages” as used herein may be text messages or other messages associated with messaging applications of any type (e.g., short messaging service (SMS) messages, multimedia messaging service (MMS) messages, chat application messages, etc.).

In examples, the improvement tool recommendation integration component 280 may integrate improvement tool recommendation data into existing communications channels. For instance, the improvement tool recommendation integration component 280 may provide instructions to one or more communications systems 294 to integrate data representing one or more improvement tool recommendations into one or more communications processed by the communications system(s) 294. For example, the communications system(s) 294 may be an email server, a messaging server, or a social media server. The improvement tool recommendation integration component 280 may instruct the communications system(s) 294 to integrate one or more presentations of improvement tools and/or one or more controls that may be activated to access one or more improvement tools into one or more emails, messages, and/or social media posts. When such content is presented to the user, the user may readily view and/or access the recommended improvement tools using the integrated data (see FIG. 12 and related text for an example of email integration). The improvement tool recommendation integration component 280 may also, or instead, instruct other communications systems to perform similar integration, such as integrating improvement tool recommendation data into calendar events, meetings, appointments, reminders, etc.

The improvement tool recommendation integration component 280 may also, or instead, instruct a user interface generation component 292 to generate an interface with user-activatable controls and/or display elements representing improvement tool recommendation data. Such interfaces may be dedicated improvement tool recommendation interfaces and/or interfaces generated by other applications into which improvement tool recommendation data may be integrated in response to instructions received from the improvement tool recommendation integration component 280. For example, the user interface generation component 292 may generate a recommendation interface on detecting user log-on to an organization's system or network data in response to instructions received from the improvement tool recommendation integration component 280. In another example, the user interface generation component 292 may be associated with a company intranet and may generate a recommendation interface integrated into an intranet homepage in response to instructions received from the improvement tool recommendation integration component 280.

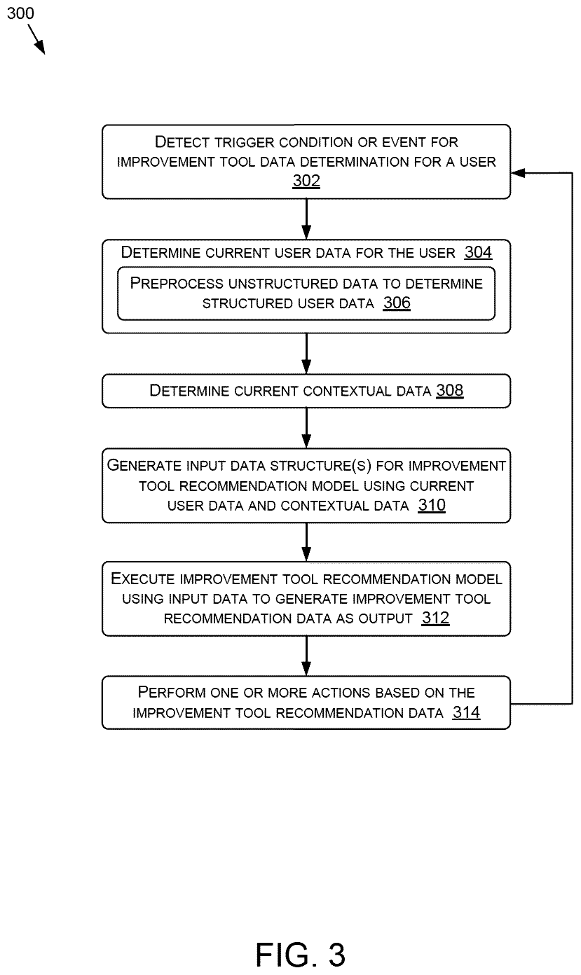

FIG. 3 illustrates an exemplary process 300 that may be implemented at an improvement tool recommendation system such as those described herein (e.g., system 100, engine 101, system 200). At 302, an event or condition may be detected that may trigger an improvement tool data determination for a particular user. For example, a user may initially log on to an interface (e.g., for the day, for a shift, etc.), a user-related event may be detected (e.g., a coaching session is detected in a calendar as scheduled for later that day, week, etc.; a time period since a previous coaching session has expired; a work anniversary is detected; a new supervisor or direct report has been assigned; an email with particular content is received at the user's inbox, etc.), a change in sentiment may be detected (e.g., a user indicated a reduced motivation or negative attitude at a daily check-in interface, a user may report a positive or negative interaction with a customer or coworker, etc.), a time period since the previous improvement tool data determination may expire, etc. Any data used herein as user data or contextual data may also serve as a data basis for an event or condition that may be detected as a triggering event or condition in an improvement tool recommendation system. Any other events and conditions may be detected to trigger an initiation of an improvement tool recommendation determination process, including, but not limited to, the examples set forth herein.

At 304, the improvement tool recommendation system may determine current user data for the particular user. This user data may include any of the user data described herein (e.g., sentiment data, employment data, training data, scheduling data, participation data, communications data (e.g., current or historical email (read and/or unread), social media posts (read and/or unread), messages (read and/or unread), and/or any content associated therewith), etc.) and/or any other data that may be associated with a particular user. In examples, such data may include unstructured data, such as text data (e.g., email content, message content, post content, etc.), audio data, and/or video data that is not organized using a pre-defined data model or in a pre-defined manner. Such data may be preprocessed at 306 to determine structured data that may be used in a data structure for input to a model. In various examples, at 106 unstructured data may be processed to identify and categorize portions of the unstructured data. The preprocessing at 306 may also, or instead, remove punctuation, filler data, silence, empty space, etc. from portions of the unstructured data. The preprocessing at 306 may also, or instead, vectorize, tokenize, or otherwise prepare the unstructured data to generate structured user data.

At 308, the improvement tool recommendation system may determine current contextual data. For example, the system may determine a time and date of the trigger event or condition, a hardware and/or software system associated with the trigger event or condition (e.g., the source to the trigger event data), an interaction or activity associated with the trigger event or condition, etc. Any other contextual data may be determined at 308, including, but not limited to, the examples set forth herein.

At 310, the improvement tool recommendation system may generate input data for one or more improvement tool recommendation models. In examples, the system may use the user data determined at 304 and the contextual data determined at 308 to generate one or more data structures representing such data (and, in examples, other data) that may serve as input to one or more improvement tool recommendation models (e.g., as described with regard to FIG. 2).

At 312, the improvement tool recommendation system may provide input data structure(s) to one or more improvement tool recommendation models. As noted herein, these models may be one or more machine-learned models, one or more rules-based models, or any combination thereof. In examples, the model(s) may also, at 312, determine or receive data representing a current or updated pool of available improvement tools. The model(s) may be executed to determine improvement tool recommendation data.

At 314, the improvement tool recommendation system may perform one or more actions based on the model output (e.g., model-generated improvement tool recommendation data). For example, the improvement tool recommendation system may generate an interface that presents one or more recommended improvement tools to the user, (e.g., as user-selectable controls that, when activated, initiate the execution of an associated improvement tool). The improvement tool recommendation system may also, or instead, generate a notification indicating recommended improvement tool(s) (or that no improvement tools are currently recommended) and/or other data (e.g., habit development progress, completed tools, current sentiment, etc.) that may be transmitted to the user and/or others (e.g., supervisor, coach, mentor, etc.). The improvement tool recommendation system may also, or instead, initiate one or more automated or partially automated processes based on the improvement tool recommendation data (e.g., initiate an action plan, schedule a meeting with a coach or mentor, etc.). The improvement tool recommendation system may also, or instead, integrate recommendation data into one or more communications and/or communications channels (e.g., email, messages, posts, etc.). Other actions, including, but not limited to, those described herein as examples, are contemplated as within the scope of the disclosure as actions that may be performed based on improvement tool recommendation data.

The process 300 may return to 402 to perform further event and/or condition detection operations and additional improvement tool recommendation operations. As described herein, the improvement tool recommendation system may then execute process 300 and/or similar processes repeatedly and/or substantially continuously for one or more users to assist in improved habit forming and skill building.

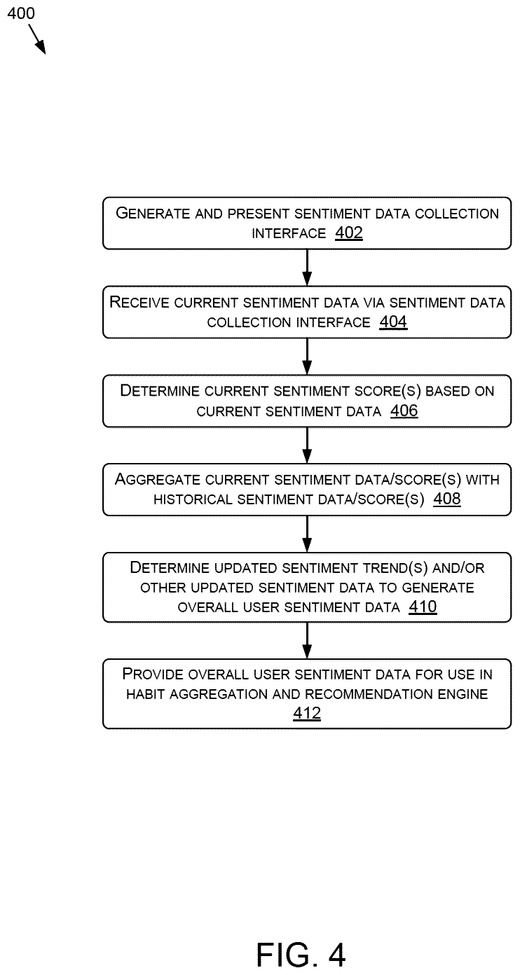

FIG. 4 illustrates an exemplary process 400 executed by a system (e.g., a sentiment determination component such as sentiment determination component 130 of FIG. 1) for determining user sentiment that may be implemented at or in conjunction with an improvement tool recommendation system such as those described herein (e.g., system 100, engine 101, system 200). At 402, the system may generate and present a sentiment data collection interface to a user. The interface may include one or more user input elements and other controls and display elements. In example, a sentiment data collection interface may present a sentiment query to the user (e.g., “How are you feeling today?”) and include a plurality of user-selectable controls for response. Individual such controls may each be associated with a distinct level or quality of user sentiment (“great,” “good,” “neutral,” “bad,” etc.). Data associated with individual such controls may be associated with or used to determine a quantitative sentiment value (e.g., score). Alternatively, the interface may include a text box or other user input element that allows the user to enter unstructured data that a sentiment determination component may process to determine a quantitative sentiment value (e.g., score). Other means of receiving, collecting, or otherwise determining user sentiment data may also, or instead, be used.

At 404, the system may receive the user sentiment data solicited by the interface. For example, in response to a user activation of a user-selectable control on the interface indicating a current sentiment, the interface may be configured to generate data representing the selection and transmit such data to the system. Alternatively or additionally, the interface may store such data (e.g., in browser memory) and the user device (e.g., executing the browser) may retrieve and transmit the data to the system. Other means of retrieving, receiving, and/or otherwise determining user sentiment data may also, or instead, be used.

At 406, the system may determine one or more sentiment scores and/or other quantitative sentiment data based on the data received at 404. For example, a simple numerical correlation may be used to determine a score based on interface element selection (e.g., (“great”=4, “good”=3, “neutral”=2, “bad”=1, etc.). In other examples, one or more algorithms or formulas may be used to generate a sentiment score based on a variety of input data, including the data received at 404 that may be processed in combination with other data to determine such a score.

At 408, the determined sentiment score(s) may be aggregated with historical data for the user associated with the sentiment score. This may include storing the most recently determined sentiment score(s) with other historical sentiment scores determined for the associated user. Storage of such sentiment scores may include storing the time and date of collection, the user device via which user sentiment input was received, etc.

At 410, the system may update one or more sentiment trends and/or other sentiment data using the most recently determined sentiment score(s). For example, the system may determine a trend line for sentiment scores and a direction of sentiment and/or a magnitude of sentiment change based on the most recently determined sentiment scores. For instance, the system may determine that the user's sentiment is trending higher or lower. The system may also, or instead, detect a sudden change in sentiment or change in the rate of change in sentiment (e.g., greater than a threshold amount of increase or decrease in sentiment or rate of change of sentiment). Any such data may be used as sentiment data as described herein that may be processed by an improvement tool recommendation model to determine improvement tool recommendations for a user.

At 412, the system may provide any subset or the entirety of any sentiment data determined in the process 400 for use as input data, or to generate input data, for an improvement tool recommendation model (e.g., sentiment data 240 of FIG. 2).

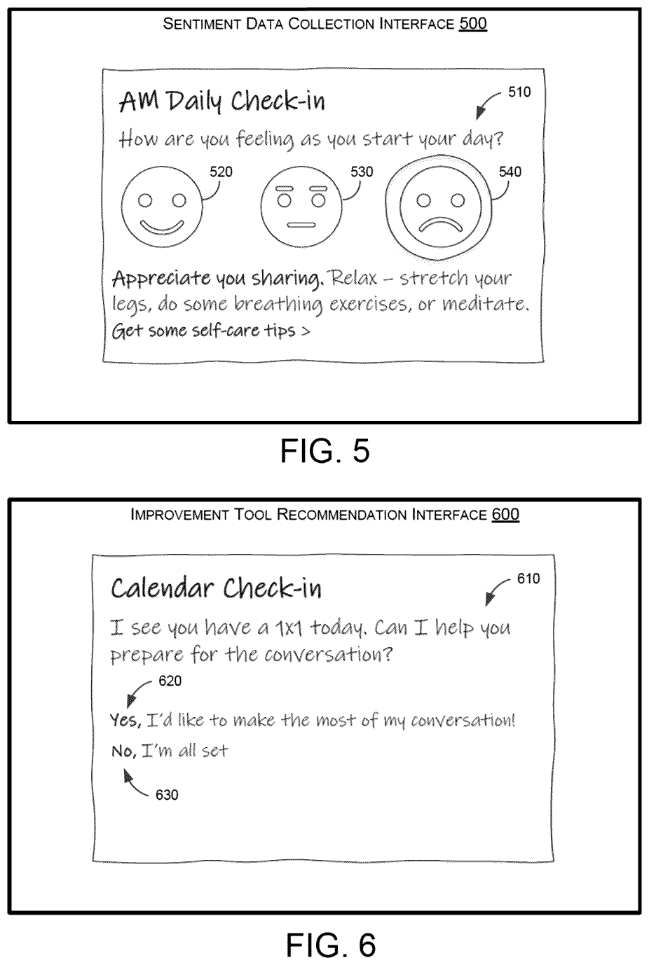

FIGS. 5-12 illustrates example user interfaces that may be generated by or in conjunction with an improvement tool recommendation system and/or associated operations. Any one or more aspects of the examples described in these figures may be combined with any one or more of the aspects described herein, and all such combinations are contemplated as within the scope of the instant disclosure.

FIG. 5 illustrates a sentiment data collection interface 500 that may be used to collect or otherwise determine, from user input, data that may be used to generate or otherwise determine current user sentiment. In examples, the interface 500 may be presented to a user when the user initially logs into the system that generates the interface (e.g., initial log-in to the user's computer, log-on to the system the user primarily uses to perform assigned tasks, a human resources system (e.g., a timekeeping system, attendance systems, etc.)). The interface 500 may collect quantified user sentiment data, for example, by allowing the user to select from a number of predetermined indications of user sentiment that may be associated with user-selectable controls. For example, the interface 500 may present a sentiment inquiry 510 that may ask the user to provide input regarding the user's sentiment. The interface 500 may further include user-selectable controls 520, 530, and 540 that may be associated with various sentiment levels or indications. In this example, the user may have selected the “sad” face associated with control 540 to indicate that the user is not feeling particularly positive today (e.g., indicating current negative sentiment), as opposed to “neutral” face associated with the control 530 that may indicate that the user is feeling neither particularly positive or negative today and the “happy” face associated with the control 520 that may indicate that the user is feeling positive today. Data may be generated and transmitted to a sentiment determination component in response to the selection of one of these controls 520, 530, and 540 as described herein. The sentiment determination component may then generate or otherwise determine a current sentiment score and/or other sentiment data for the user based on this data. The determined sentiment data may then be collected and stored for use as user data in determining improvement tool recommendations and/or as data that may be processed to determine improvement tool recommendation system triggering events or conditions. The determined sentiment data may also, or instead, be collected and stored for use as training data for training one or more improvement tool recommendation models.

Based on the sentiment data determined based on input data received via the interface 500 and, in examples, other data (e.g., user data and/or contextual data), the improvement recommendation system may determine to execute an improvement tool recommendation process. For example, an improvement tool recommendation system may determine, based on the sentiment data collected from the user and scheduling data indicating a scheduled one-on-one meeting stored in the user's calendar, to generate improvement tool recommendation data. The improvement tool recommendation system may collect the relevant user and/or contextual data, generate one or more model input data structures based on such data, and execute one or more improvement tool recommendation models using such data structure(s) as input to generate improvement tool recommendation data as output. The generated improvement tool recommendation data may include improvement tool recommendations and/or actions.

For example, FIG. 6 illustrates an improvement tool recommendation interface 600 that may be generated based on such improvement tool recommendation data. As can be seen here, the improvement tool recommendation data may cause an improvement tool model to recommend presenting a recommendation 610 that recommends a particular improvement tool to the user. Here, the interface 600 presents the recommendation 610 indicating that a one-on-one meeting scheduled for later in the day has been detected and that an improvement tool (e.g., determined by an improvement tool recommendation model) may be helpful for this meeting. The interface 600 may further present user-selectable control 620 that, when activated, may present the recommended improvement tool and/or otherwise initiate execution of the recommended improvement tool The interface 600 may further present user-selectable control 630 that, when activated, declines use of the recommended improvement tool.

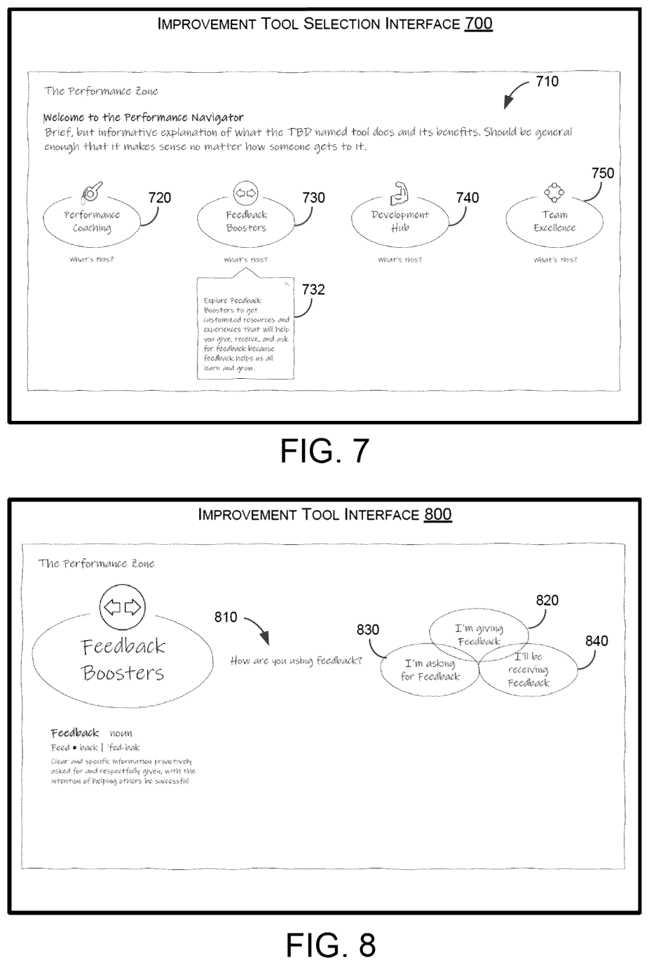

Selection of a recommended improvement tool control may generate one or more other interfaces. For example, FIG. 7 illustrates an example improvement tool selection interface 700 that may be generated and presented to the user, for example in response to activation of control 620 of interface 600 of FIG. 6. The interface 700 may present a summary of the content of the improvement tool 710 and options within the tool and various user-selectable controls 720, 730, 740, and 750 that may provide more information about various tool options and aspects, access to other tool components, and/or initiation of executable aspects of the improvement tool. The interface 700 may also include display elements presenting additional details, such as display element 732 that displays more information about the aspect of the improvement tool associated with the user-selectable control 730 (e.g., when the hovers on or over the control 730 or clicks (e.g., right clicks) the control 730). In this example, the user may have the option to select, or may be prompted or otherwise recommended to select (e.g., by content of the display element 732), “feedback boosters” option associated with control 730 that may be applicable to the current user and context data (e.g., of the user having a one-on-one meeting later in the day and a relatively negative current sentiment).

Selection of the “feedback boosters” control 730 on interface 700 may cause the improvement tool system to generate an improvement tool interface 800 as illustrated in FIG. 8. The interface 800 may present the user with additional information and options to tailor the improvement tool to the user's situation. For example, the user may be presented with additional information on feedback and a tool use inquiry 810 (“how are you using the feedback?”). The interface 800 may further include user-selectable controls 820, 830, and 840 that may be selected to respond to the tool use inquiry 810 and generate additional material associated with various feedback situations (e.g., giving feedback associated with control 820, asking for feedback associated with control 830, receiving feedback associated with control 840).

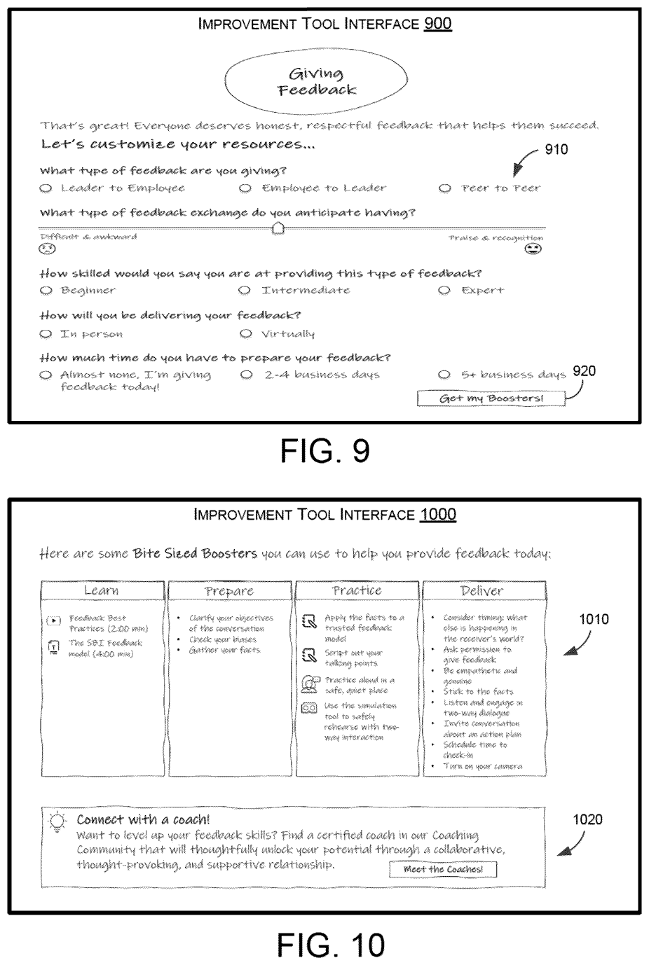

The user may select the control 820 associated with giving feedback in interface 800, which may cause the improvement tool system to generate and present the improvement tool interface 900 illustrated in FIG. 9. The interface 900 may provide more information on feedback and may solicit responses to various queries 910 regarding the feedback that the user anticipates providing (e.g., to a coworker, supervisor, direct report, etc.). The user may submit the responsive data using a user-selectable control 920 configured on this interface (e.g., “Get my boosters!”). The improvement tool recommendation system may then determine further material and/or improvement tool(s) to provide to the user. For example, the selection of the responsive data submission control 920 may be a trigger that initiates a data transmission to the improvement tool system to generate input data for the improvement tool recommendation model(s) to use to generate additional improvement tool recommendation data. Alternatively or additionally, the selection of the responsive data submission control 920 may cause the generation of a subsequent interface and/or other material associated with the currently executing improvement tool.

For example, improvement tool interface 1000 of FIG. 10 may be generated based on the selection of the responsive data submission control 920. The interface 1000 may include improvement tool information 1010 that may be generated within and/or by the currently executing improvement tool. Information 1010 may also, or instead, be determined by an improvement tool recommendation system based on model output. The interface 1000 may provide the information 1010 to the user for use in the upcoming one-on-one meeting where the user will be providing feedback to another. The interface 1000 may further provide a user-selectable control 1020 to access one or more additional improvement tools. For example, the control 1020 may initiate access to coaching resources (“Meet the Coaches!”).

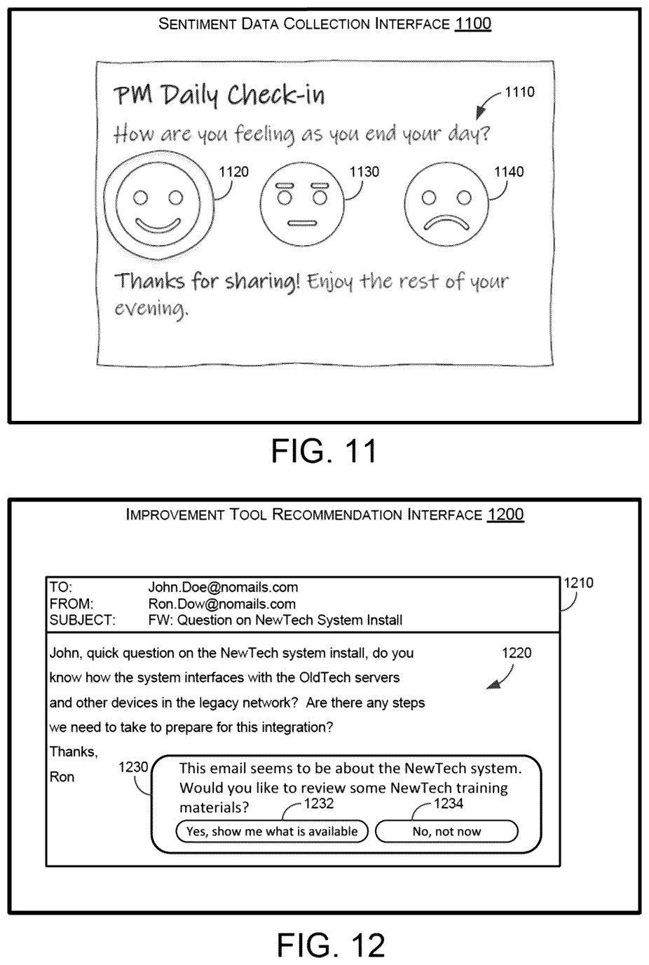

FIG. 11 illustrates a sentiment data collection interface 1100 that may be presented to a user at a later time, for example, a time later in the same day during which the interface 500 of FIG. 5 was presented to the user. The use of the interface 1100 may allow the sentiment to determine an updated sentiment for the user and track how the user's sentiment changes over the course of the day. The system may perform such sentiment data collection periodically throughout the day and/or in response to triggers and/or timers.

Similar to the interface 500, the interface 1100 may present a sentiment inquiry 1110 that may ask the user to provide input regarding the user's current sentiment. The interface 1100 may further include user-selectable controls 1120, 1130, and 1140 that may be associated with various sentiment levels or indications. In this example, the user may have selected the “happy” face associated with control 1120 to indicate that the user is feeling positive at this point in the day (e.g., indicating current positive sentiment), as opposed to “neutral” face associated with the control 1130 that may indicate that the user is feeling neither particularly positive or negative today and the “sad” face associated with the control 1140 that may indicate that the user is feeling generally negative today. Data may be generated and transmitted to a sentiment determination component in response to selection of one of these controls 1120, 1130, and 1140 as described herein. The sentiment determination component may then generate or otherwise determine a current sentiment score and/or other sentiment data for the user based on this data, including updating any sentiment-related data based on the most recently determined sentiment score and/or data. The determined sentiment data may then be collected and stored for use as user data in determining improvement tool recommendations and/or as data that may be processed to determine improvement tool recommendation system triggering events or conditions. The determined sentiment data may also, or instead, be collected and stored for use as training data for training one or more improvement tool recommendation models.

FIG. 12 illustrates an improvement tool recommendation interface 1200 that may be an improvement tool recommendation integrated into a (e.g., non-improvement tool related) communications channel. In this example, an email 1210 may be received at an email application or server and associated with a particular user (e.g., stored in the user's inbox). An improvement tool recommendation model may have determined, based on input data such as communications data representing the email 1210 (e.g., data representing the content 1220 of the email 1210), an improvement tool to recommend and a communications channel means of recommending the tool. In this example, the model may have determined to provide the recommendation as an improvement tool data presentation element 1230 integrated into the email 1210. The interface 1200 may further present user-selectable controls 1232 and 1234 integrated into the improvement tool data presentation element 1230 that is itself integrated into the email 1210. The control 1232, when activated, may present the recommended improvement tool and/or otherwise initiate execution of the recommended improvement tool. The control 1234, when activated, may decline the use of the recommended improvement tool.

FIG. 13 illustrates several improvement tool recommendation generation process examples 1300. In example 1310 (“New Leader Example”), the hire of a new leader may be an event that triggers the collection of data and execution of one or more improvement tool recommendation models in an improvement tool recommendation system. Based on detecting the new leader hire (e.g., creation or completion of leader position data in a human resources system, detection of a communication indicating the hire, etc.) in a human resources system (e.g., a Human Capital Management System or “HCMS”) and/or a hiring platform (e.g., “Candidate Relationship Manager”), the improvement tool recommendation system may collect user and/or contextual data from one or more sources, which may include, but are not limited to, the human resources system and the hiring platform. Using this data, the improvement tool recommendation system may execute one or more improvement tool recommendation models to generate improvement tool recommendation data. The generated improvement tool recommendation data may initiate, or cause the initiation of, an action of presenting an improvement tool to the user (“nudging” the user with the “New Hire Welcome Kit”).

In example 1320 (“REAL Insights Example”), a user sentiment inquiry and/or determination (“REAL Insights Pulse Check”) may be an event that triggers the collection of data and execution of one or more improvement tool recommendation models in an improvement tool recommendation system. Based on the determined user sentiment (e.g., receiving user input responsive to a sentiment inquiry, a determination of a sentiment score based on the input, etc.) collected, for example, in a human resources system (“HCMS”), the improvement tool recommendation system may collect user and/or contextual data from one or more data sources, which may include, but are not limited to, the human resources system. Using this data, the improvement tool recommendation system may execute one or more improvement tool recommendation models to generate improvement tool recommendation data. The generated improvement tool recommendation data may initiate, or cause the initiation of, an action of presenting an improvement tool to the user (email the user with an action plan that may include one or more of various improvement tool resources or recommendations).

In example 1330 (“Outlook Mtg Example”), a one-on-one meeting in which a user participated (“1 v 1”) may be an event that triggers the collection of data and execution of one or more improvement tool recommendation models in an improvement tool recommendation system. Based on the detected meeting (e.g., detected based on analysis of a user calendar, scheduling data, supervisor calendar, communications associated with the meeting, etc.) in a communications system (e.g., “OUTLOOK”), the improvement tool recommendation system may collect user and/or contextual data from one or more data sources that may include, but are not limited to, the communications system. Using this data, the improvement tool recommendation system may execute one or more improvement tool recommendation models to generate improvement tool recommendation data. The generated improvement tool recommendation data may initiate, or cause the initiation of, an action of presenting an improvement tool to the user (“nudging” the user with a “coaching habit card” that may indicate one or two quick habit improvement exercises).

In example 1340 (“Check-In Example”), the opening of an intranet homepage may be an event that triggers the collection of data and execution of one or more improvement tool recommendation models in an improvement tool recommendation system. Based on detecting the opening of the intranet homepage (e.g., detection of user log-in, generation of the homepage for the user, etc.) in a human resources system (“HCMS”), the improvement tool recommendation system may collect user and/or contextual data from one or more data sources, which may include, but are not limited to, the human resources system and the hiring platform. Using this data, the improvement tool recommendation system may execute one or more improvement tool recommendation models to generate improvement tool recommendation data. The generated improvement tool recommendation data may initiate, or cause the initiation of, an action of presenting an improvement tool to the user (“nudging” the user with the customized content based on the user data). For example, a check-in interface soliciting user sentiment may be presented within the human resources system.

In example 1350 (“Milestone Example”), a determined milestone for a user (“Milestone in the employee journey”) may be an event that triggers the collection of data and execution of one or more improvement tool recommendation models in an improvement tool recommendation system. Based on the detected milestone (e.g., detected based on analysis of a user calendar, scheduling data, data calculated based on hire date or date of occupation of a current position, etc.) in a human resources system (e.g., “HCMS”), the improvement tool recommendation system may collect user and/or contextual data from one or more data sources that may include, but are not limited to, the human resources system. Using this data, the improvement tool recommendation system may execute one or more improvement tool recommendation models to generate improvement tool recommendation data. The generated improvement tool recommendation data may initiate, or cause the initiation of, an action of presenting an improvement tool to the user (“nudging” the user with “customized content to complement milestone,” a congratulations message, etc.).

In example 1360 (“Perf. Improvement Example”), a performance improvement plan associated with a user (“Perf. Improvement Plan”) and/or an event or condition associated with such a plan may be an event that triggers the collection of data and execution of one or more improvement tool recommendation models in an improvement tool recommendation system. Based on the detected plan, plan event, or plan condition (e.g., detected based on completion of an activity, expiration of a time period associated with the plan or a plan activity, etc.) in a human resources system (e.g., “HCMS”), the improvement tool recommendation system may collect user and/or contextual data from one or more data sources that may include, but are not limited to, the human resources system. Using this data, the improvement tool recommendation system may execute one or more improvement tool recommendation models to generate improvement tool recommendation data. The generated improvement tool recommendation data may initiate, or cause the initiation of, an action of presenting an improvement tool to the user (“nudging” the user to participate in a “coaching gym” in a particular environment (e.g., “Metaverse”) that may assist the user in improving habits according to the performance improvement plan).

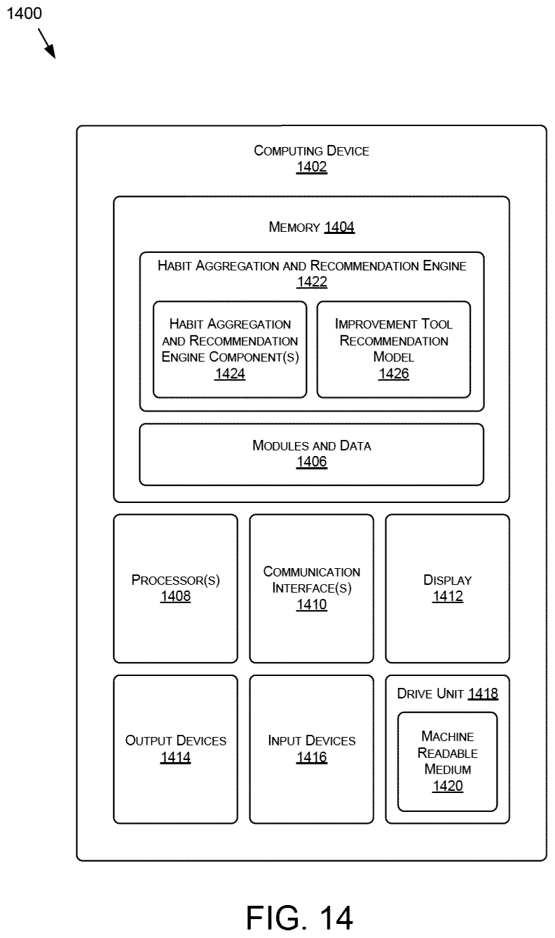

FIG. 14 shows an example system architecture 1400 for a computing device 1402 that may be implemented as (e.g., part of) any of the systems and devices described herein and/or may perform any of the operations and processes described herein. For example, the computing device 1402 may represent any of the systems, devices, and components illustrated in FIG. 1 and/or FIG. 2. Moreover, the computing device 1402 may represent any system configured to generate any of the interfaces described in regard to FIGS. 5-12 and/or any other interface described herein. Furthermore, the computing device 1402 may represent any system configured to implement any of the operations described in regard to FIGS. 3 and 4 and/or any other operation described herein. The computing device 1402 may be a server, computer, mobile device (e.g., smartphone, smartwatch), vehicle component, vehicle computing system, or any other type of computing device that may execute any of the operations described herein. In some examples, operations as described herein may be distributed among and/or executed by multiple computing devices 1402.

A computing device 1402 can include memory 1404. In various examples, the memory 1404 can include system memory, which may be volatile (such as RAM), non-volatile (such as ROM, flash memory, etc.), or some combination of the two. The memory 1404 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 1402. Any such non-transitory computer-readable media may be part of the computing devices 1402.

The memory 1404 may include modules and data 1406 needed to perform operations as described herein by one or more computing devices 1402. Included with such modules and data 1406 and/or also stored in the memory 1404 may be a habit aggregation and recommendation engine 1422 that may include one or more habit aggregation and recommendation engine components 1424 and/or one or more improvement tool recommendation models 1426. The habit aggregation and recommendation engine component(s) 1424 may perform any one or more of the operations related to improvement tool recommendations as described herein. The improvement tool recommendation model(s) 1426 may be executed using any of the input data as described herein to generate model output that may include any of the improvement tool recommendation data as described herein.

One or more computing devices 1402 may also have processor(s) 1408, communication interface(s) 1410, display(s) 1412, output device(s) 1414, input device(s) 1416, and/or drive unit(s) 1418 that may include one or more machine-readable media 1420.

In various examples, the processor(s) 1408 can be a central processing unit (CPU), a graphics processing unit (GPU), both a CPU and a GPU, or any other type of processing unit. Each of the one or more processor(s) 1408 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 1408 may also be responsible for executing computer applications stored in the memory 1404, which can be associated with common types of volatile (RAM) and/or nonvolatile (ROM) memory.

The communication interfaces 1410 may include transceivers, modems, interfaces, antennas, telephone connections, and/or other components that can transmit and/or receive data over networks, telephone lines, or other connections.

The display(s) 1412 can be any one or more of a liquid crystal display or any other type of display commonly used in computing devices. For example, the display(s) 1412 may include a touch-sensitive display screen that may also act as an input device or keypad, such as for providing a soft-key keyboard, navigation buttons, and/or any other type of input.

The output device(s) 1414 may include any sort of output devices known in the art, such as the display(s) 1412, one or more speakers, a vibrating mechanism, and/or a tactile feedback mechanism. Output devices 1414 may also include one or more ports for one or more peripheral devices, such as headphones, peripheral speakers, and/or a peripheral display.

The input device(s) 1416 may include any sort of input devices known in the art. For example, input device(s) 1416 may include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable media 1420 of drive unit(s) 1418 may store one or more sets of instructions, such as software or firmware, that embodies any one or more of the methodologies or functions described herein. The instructions can also reside, completely or at least partially, within the memory 1404, processor(s) 1408, and/or communication interface(s) 1410 during execution thereof by the one or more computing devices 1402. The memory 1404 and the processor(s) 1408 may also constitute machine-readable media 1420.

With the techniques described herein, improvement tools can be more accurately and appropriately identified and recommended to users in a sizable organization without requiring human analysis and data processing, thereby increasing the efficient use of resources that may otherwise need to be manually operated to perform such recommendation determinations.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
receiving, by an improvement tool data determination system, user data comprising:
subjective user data associated with a user,
communications channel data associated with the user, and
timing data associated with the user;
generating, by the improvement tool data determination system, an input data structure based on the user data;
executing, by the improvement tool data determination system, an improvement tool data determination component using the input data structure as input to generate improvement tool data output,
wherein the improvement tool data determination component is configured to determine and provide, in the improvement tool data output, based at least in part on the subjective user data, the communications channel data, and the timing data, a communications channel, a time window, and an improvement tool;
generating, by the improvement tool data determination system, based at least in part on the communications channel and the improvement tool, an improvement tool data presentation element comprising an indication of the improvement tool; and
presenting, by the improvement tool data determination system, based at least in part on the time window, the improvement tool data presentation element on a computing device.

2. The method of claim 1, wherein the improvement tool data presentation element comprises a user-selectable control that, when activated, initiates execution of the improvement tool.

3. The method of claim 1, wherein presenting the improvement tool data presentation element comprises integrating the improvement tool data presentation element into a communication associated with the communications channel.

4. The method of claim 3, wherein the communication is one of an email, a message, or a social media post.

5. The method of claim 1, wherein the improvement tool data determination component comprises one or more of a machine-learned model or a rules-based model.

6. The method of claim 1, wherein the subjective user data comprises one or more of current user sentiment data or historical user sentiment data.

7. The method of claim 1, wherein the time window is associated with a scheduled event associated with the user and represented in the timing data.

8. A non-transitory computer-readable medium comprising instructions that, when executed by one or more computer processors, cause the one or more computer processors to perform operations comprising:
receiving user data comprising subjective user data associated with a user, communications channel data associated with the user, and timing data associated with the user;
generating an input data structure based on the user data;
executing an improvement tool data determination model using the input data structure as input to generate improvement tool data output,
wherein the improvement tool data determination model is trained to determine and provide, in the improvement tool data output, based at least in part on the subjective user data, the communications channel data, and the timing data, a communications channel, a time window, and an improvement tool;
generating based at least in part on the communications channel and the improvement tool, an improvement tool data presentation element comprising an indication of the improvement tool; and
presenting, based at least in part on the time window, the improvement tool data presentation element on a computing device.

9. The non-transitory computer-readable medium of claim 8, wherein presenting the improvement tool data presentation element comprises integrating the improvement tool data presentation element into a communication associated with the communications channel.

10. The non-transitory computer-readable medium of claim 9, wherein the communication is one of an email, a message, or a social media post.

11. The non-transitory computer-readable medium of claim 8, wherein the time window is associated with a scheduled event associated with the user and represented in the timing data.

12. The non-transitory computer-readable medium of claim 8, wherein the subjective user data comprises data representing one or more of a change of user sentiment data or a rate of change of user sentiment data.

13. The non-transitory computer-readable medium of claim 8, wherein the communications channel data comprises data representing content of communications associated with a communications channel.

14. A system comprising:
one or more processors; and
a non-transitory memory storing computer-executable instructions that, when executed, cause the one or more processors to perform operations comprising:
receiving user data comprising subjective user data associated with a user, communications channel data associated with the user, and timing data associated with the user;
generating an input data structure based on the user data;
executing an improvement tool data determination model using the input data structure as input to generate improvement tool data output,
wherein the improvement tool data determination model is trained to determine and provide, in the improvement tool data output, based at least in part on the subjective user data, the communications channel data, and the timing data, a communications channel, a time window, and an improvement tool;
generating based at least in part on the communications channel and the improvement tool, an improvement tool data presentation element comprising an indication of the improvement tool; and
presenting, based at least in part on the time window, the improvement tool data presentation element on a computing device.

15. The system of claim 14, wherein the communications channel data comprises data representing content of communications associated with a communications channel.

16. The system of claim 14, wherein presenting the improvement tool data presentation element comprises integrating the improvement tool data presentation element into a communication associated with the communications channel.

17. The system of claim 16, wherein the communication is one of an email, a message, or a social media post.

18. The system of claim 14, wherein presenting the improvement tool data presentation element comprises generating a graphical user interface comprising the improvement tool data presentation element.

19. The system of claim 14, wherein the subjective user data comprises data representing a user sentiment data trend.

20. A system for determining improvement tool recommendation data, the system comprising:
means for receiving user data comprising subjective user data associated with a user, communications channel data associated with the user, and timing data associated with the user;
means for generating an input data structure based on the user data;
means for executing an improvement tool data determination model using the input data structure as input to generate improvement tool data output,
wherein the improvement tool data determination model is trained to determine and provide, in the improvement tool data output, based at least in part on the subjective user data, the communications channel data, and the timing data, a communications channel, a time window, and an improvement tool;
means for generating based at least in part on the communications channel and the improvement tool, an improvement tool data presentation element comprising an indication of the improvement tool; and
means for presenting, based at least in part on the time window, the improvement tool data presentation element on a computing device.
